(19) United States
(12) Patent Application Publication
(10) Pub. No.: US 2017/0223119 A1
(43) Pub. Date: Aug. 3, 2017

(54) Geospatial aware queueing

(71) Applicant: SnoOwl, Inc., Fall River, MA (US)

(72) Inventor: Joshua Harding, New Bedford, MA (US)

(21) Appl. No.: 15/331,862

(22) Filed: Oct. 22, 2016

Related U.S. Application Data
(60) Provisional application No. 62/245,439, filed on Oct. 23, 2015.

(51) Int. Cl. H04L 29/08; H04W 4/02

(52) U.S. Cl. CPC H04L 67/18; H04W 4/021

(57) ABSTRACT

Systems and methods for geospatial aware queuing of information retrieval requests are described. A representation of a geographical area is divided into a plurality of subareas, and a request for information relating to a location of a user device in a first one of the subareas is received. The subareas are each assigned a different priority, and information associated with one or more of the subareas is retrieved based on the assigned priorities. The retrieved information is then provided to the user device.

### CROSS-REFERENCE TO RELATED APPLICATIONS

This application claims priority to and the benefit of U.S. Provisional Patent Application No. 62/245,439, filed on Oct. 23, 2015, which is hereby incorporated herein by reference in its entirety.

### TECHNICAL FIELD

The present disclosure relates generally to data processing and, more particularly, to systems and methods for providing location-based, real-time geospatial data streams to end users.

### BACKGROUND

Data sources including social media websites, such as Facebook, aggregate a substantial amount of data on their users. Some of this data is made available to developers or to the general public through an application programming interface (API). For example, an application developer can use a Facebook API to retrieve data associated with a particular person, business, or other item of interest. However, to avoid straining and prevent abuse of such data sources, constraints are often put in place regarding the manner in which information can be obtained. Facebook, for example, limits both the query rate and area of interest associated with a particular query. The ability for a developer to provide real-time data access to its users via such an API is therefore significantly limited.

### SUMMARY

Systems and methods for geospatial aware queuing of requests for social media information and other data associated with a geographical area are described. In one aspect, a computer-implemented method includes: dividing a representation of a geographical area into a plurality of subareas; receiving a request for information relating to a location of a user device in a first one of the subareas; assigning a different priority to each of the subareas; retrieving information associated with one or more of the subareas based at least in part on the assigned priorities; and providing the retrieved information to the user device.

Various implementations of this aspect can include the following features. The subareas can include circular subareas, and can be arranged in an overlapping honeycomb pattern. The retrieved information can include at least one of a social media post, information associated with a person, information associated with a business, and information associated with a geographical location. The assigning of a priority to a particular subarea can be based on a distance of the particular subarea from the location of the user device. The assigning can include: assigning a first priority to a first one of the subareas; and assigning a different priority lower than the first priority to each other subarea. The information can be retrieved via a query-rate-limited application programming interface.

In another implementation, the method further includes receiving a request for information relating to a location of a second user device in a second one of the subareas; and modifying the priority assigned to one or more of the subareas based on a distance of each of the one or more subareas from the location of the second user device.

Other aspects of the invention include corresponding systems and computer programs. The details of one or more implementations of the subject matter described in the present specification are set forth in the accompanying drawings and the description below. Other features, aspects, and advantages of the subject matter will become apparent from the description, the drawings, and the claims to persons of ordinary skill in the art and are considered to be within the scope of this disclosure.

### BRIEF DESCRIPTION OF DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings, in which:

FIG. 1 illustrates an exemplary system for geospatial aware queuing in accordance with one embodiment;

FIG. 2 depicts a flowchart of an exemplary method for geospatial aware queuing using the system of FIG. 1 in accordance with one embodiment;

FIG. 3 illustrates an exemplary geographical area divided into subareas in accordance with one embodiment; and

FIG. 4 illustrates an exemplary heat map of a geographical area in accordance with one embodiment.

### DETAILED DESCRIPTION

Described herein are systems and methods for simulating real-time data access through an API that is limited by query rate and/or other factors. For example, for any given social network with an API (e.g., an interface to allow external platforms to retrieve data), there is only a certain amount of data that can be pulled at any one point in time. The challenge is how to have fresh data for all users, no matter where they are. Facebook, for instance, does not allow unconstrained, real-time access to its data and limits certain API calls such that only 1 km circles can be queried, at the rate of one per second, per user (i.e., the party retrieving data using the API). In order to create the illusion of real-time access to data obtained via such an API without actually having real-time access, as well as to also be able to show more than a 1-km area to an end user, the disclosed system utilizes message-based prioritized queuing, in which social media imports are scheduled and prioritized with dynamic priorities, depending on current user distribution across the world. To this end, a geographical area is divided into portions, and the portions are assigned priorities indicating the order in which data associated with the particular portion will be retrieved using the API.

Although the features of various embodiments described herein are generally described in the context of receiving data from Facebook, it is contemplated that other sources of data may be used in accordance with the features of the present invention. For example, the geospatial aware queueing system and methods may be used to pull data from data sources such as Instagram, Pinterest, Four Square, Twitter, LinkedIn, other social media sources with query rate and/or geography limits, or the like.

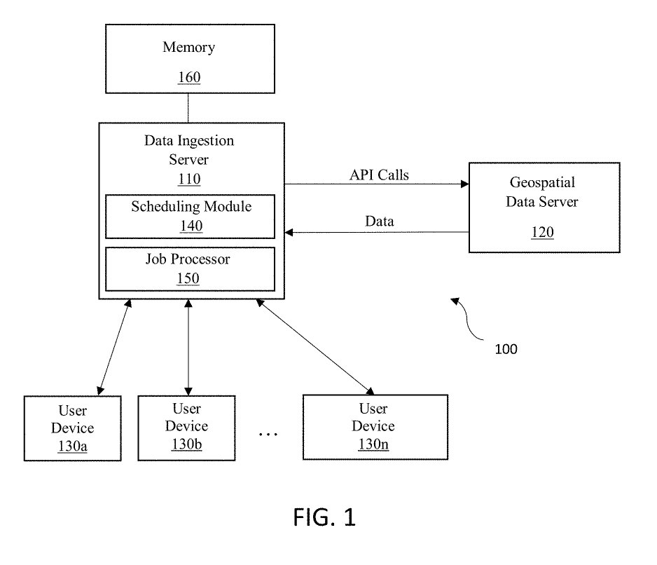

Referring to FIG. 1, one implementation of a system 100 for geospatial aware queuing includes a data ingestion server 110 in communication with a geospatial data server 120. The geospatial data server 120 can be, for example, a server provided by a social media platform (e.g., Facebook, Twitter), content provider, data aggregator, or other source of data, and can include a data store that includes geospatial data associated with individuals, businesses, locations, roadways, points of interest, and so on. Such a data store can be, for example, a relational or other structured database such as the MySQL Database Server or Oracle® Database Server, the PostgreSQL Database Server, or the IBM DB2 Database Server.

The data ingestion server 110 may communicate over a network with user devices 130a . . . 130n. For example, data ingestion server 110 can receive requests for data from one or more of the user devices 130a . . . 130n and, in response, transmit to one or more of the user devices 130a . . . 130n data ingested from geospatial data server 120 in the same or a modified format. The data ingestion server 110 can retrieve data from the geospatial data server 120 using, for example, an API made available to developers, and process the data into a form usable by the user devices 130a . . . 130n. The data ingestion server 110 may include a scheduling module 140 that can choose for which area(s) of the globe to request data from the geospatial data server 120 based on assigned priorities, further described below. In this way, the data ingestion server 110 can be kept busy continuously and can choose the optimum area for data ingestion, even as users travel around the globe, thereby maintaining an even balance of content worldwide. The data ingestion server 110 may further include a job processing module 150 for dequeuing the information requests from the queue (discussed below).

The system 100 may also include at least one memory 160 in communication with the data ingestion server 110. The memory 160 may store instructions for the data ingestion server 110 to execute the various steps of the methods described herein. Data may be cached or otherwise stored not only for a single user, but for all users using the systems and methods described herein. This information-sharing aspect may further enhance the user experience, as more relevant information may be provided to a single end user and/or business.

The user devices 130a . . . 130n can include software, such as a native application that displays information (e.g., social media posts, business information, personal information, etc.) associated with the area and/or objects in the area surrounding the device user (e.g., a 1 km radius from the latitude and longitude of the user). Some or all of the information can be requested and received from the data ingestion server 110. A particular user device 130a . . . 130n can be a smartphone, tablet computer, smart watch, smart glasses, portable computer, mobile telephone, laptop, palmtop, smart television, desktop computer, wireless device, appliance, workstation, and/or other computing device that is operated as a general purpose computer or as a special purpose hardware device capable of executing the functionality described herein as being provided by the user devices 130a . . . 130n. The user devices 130a . . . 130n can each include a GPS sensor, wireless radio, or other sensor, transmitter and/or receiver that can be used to determine the exact or approximate location of a user device 130a . . . 130n.

More generally, implementations of the present system can use appropriate hardware or software. For example, the data ingestion server 110 and/or user devices 130a . . . 130n can execute application software on an operating system such as the Microsoft Windows® operating systems, the Apple OS X® operating systems, the Apple iOS® platform, the Google Android™ platform, the Linux® operating system and other variants of UNIX® operating systems, and the like. Such software can be implemented on a general purpose computing device in the form of a computer including a processing unit, a system memory, and a system bus that couples various system components including the system memory to the processing unit.

Some of the functionality described herein can be performed remotely, in the cloud, or via software-as-a-service. For example, functions provided by the data ingestion server 110 can be performed on one or more servers or other devices that can communicate with user devices 130a . . . 130n and/or with each other. Such remote functionality can execute on server class computers that have sufficient memory, data storage, and processing power and that run a server class operating system (e.g., Oracle® Solaris®, GNU/Linux®, and the Microsoft® Windows® family of operating systems).

The system can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application implemented in a suitable programming language or framework.

Method steps of the techniques described herein can be performed by one or more programmable processors executing one or more computer programs to perform functions by operating on input data and generating output. Method steps can also be performed by, and systems can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor receives instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in, special purpose logic circuitry.

In some implementations, the user devices 130a . . . 130n include a web browser, native application, or both, that facilitates execution of the functionality described herein. A web browser allows the device to request a web page or other program, applet, document, or resource (e.g., from a remote server, such as a web server) with an HTTP request. One example of a web page is a data file that includes computer executable or interpretable information, graphics, sound, text, and/or video, that can be displayed, executed, played, processed, streamed, and/or stored and that can contain links, or pointers, to other web pages. Examples of commercially available web browser software include the Google® Chrome™, Microsoft® Internet Explorer®, Mozilla® Firefox®, and Apple® Safari® browsers.

In other implementations, the user devices 130a . . . 130n include client software that provides for the implementation and execution of certain features described herein. The client software can be implemented in various forms. For example, the client software can be in the form of a native application, web page, widget, and/or Java, JavaScript, .Net, Silverlight, Flash, and/or other applet or plug-in that is downloaded to the device and runs in conjunction with a web browser. The client software and the web browser can be part of a single client-server interface; for example, the client software can be implemented as a plug-in to the web browser or to another framework or operating system. Other suitable client software architecture, including but not limited to widget frameworks and applet technology, can also be employed with the client software.

A communications network can facilitate communication among two or more of the data ingestion server 110, the geospatial data server 120, and user devices 130a . . . 130n. The communication can take place over media such as standard telephone lines, LAN or WAN links (e.g., T1, T3, 56 kb, X.25), broadband connections (ISDN, Frame Relay, ATM), and wireless links (802.11 (Wi-Fi), Bluetooth, GSM, CDMA, etc.), for example. Other communication media are contemplated. The network can carry TCP/IP protocol communications and HTTP/HTTPS requests made by a web browser, and the connection between devices and/or servers can be communicated over such TCP/IP networks. Other communication protocols are contemplated.

The system can also be practiced in distributed computing environments, where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems, such as those mentioned above, and that operate on one or more computers having hardware, such as that described herein.

It should also be noted that implementations of the systems and methods can be provided as one or more computer-readable programs embodied on or in one or more articles of manufacture. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

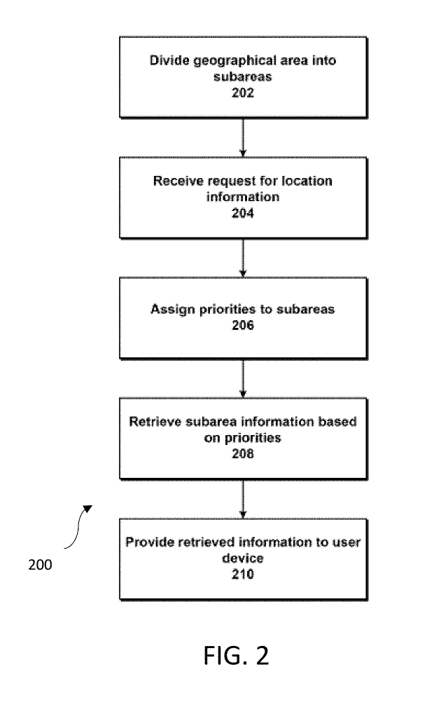

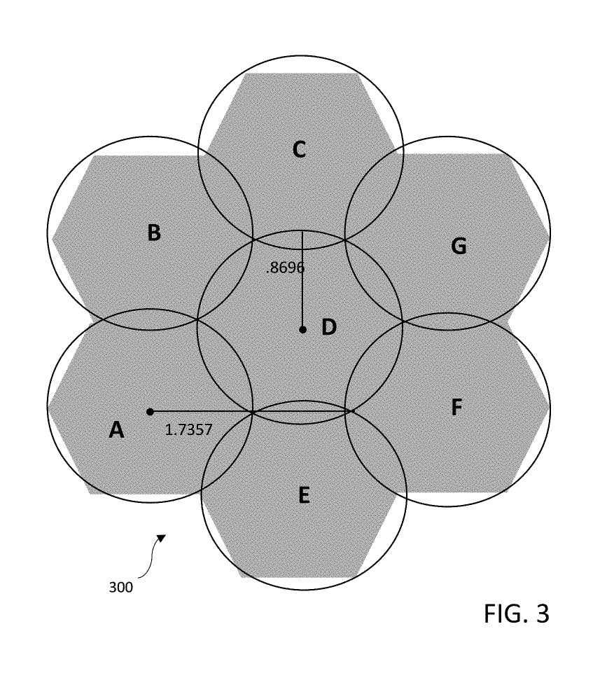

FIG. 2 depicts one implementation of a method 200 for geospatial aware queuing of information retrieval queries using the system of FIG. 1. In STEP 202, data ingestion server 110 divides a representation of a geographical area into a plurality of subareas. For example, as shown in FIG. 3, a geographical area 300 is divided into multiple circles A-G, each having a 1-km radius, and arranged in a minimally-overlapping honeycomb pattern. By arranging the subareas as shown, each coordinate on the map is ingested at least once. Other shapes of subareas and arrangements of subareas are contemplated. For example, a particular API may allow for polygonal areas to be queried, thereby avoiding overlap in subareas.

In STEP 204, the data ingestion server 110 receives a request for information from one or more of the user devices 130a . . . 130n that is/are within the geographical area. The information requested can be, for example, social media posts or other information relating to persons, businesses, points of interest, and/or geographical locations proximate to the requesting user device(s) 130a . . . 130n. In STEP 206, based on the location(s) of the requesting device(s) 130a . . . 130n, the data ingestion server 110 assigns priorities to some or all of the subareas of the geographical area. If, for example, there is a single requesting user device 130a, then the subarea in which the requesting device 130a is located can be assigned the highest priority. Surrounding subareas can then be assigned different, lower priorities based on the distance of those subareas from the requesting device location (e.g., decreasing priorities as the subareas increase in distance from the requesting device location).

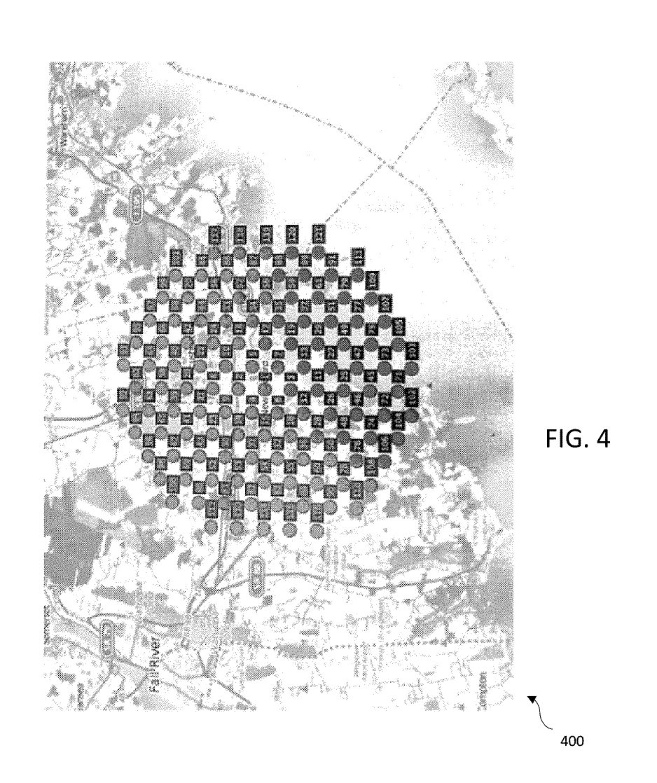

In the event that there are multiple user devices 130a . . . 130n requesting information for overlapping areas, the divided geographic area can be treated as a “heat map,” such that subareas that are common to more than one user device 130a . . . 130n can have their priorities increased. For example, if user device 130a requests information relating to subareas A, B, C, and D, and user device 130b requests information relating to subareas D, E, F, and G, then the priority assigned to subarea D can be increased relative to other subareas for which fewer devices are requesting information. FIG. 4 depicts one example of a heat map 400 with subareas having assigned priorities (priority 1 is the highest priority for retrieval in the queue, higher numbers indicate later positions in the queue and, thus, lower priorities).

In some instances, if there is a priority collision during scheduling (i.e., a new subarea to request has the same priority as an existing subarea in the queue), the two priorities can be added together. For example, if an existing job has a priority of 35 and a new request is made with priority 20, the resulting priority is 55. Other methods of resolving priority conflicts are contemplated. The following is one specific implementation of method for assigning priorities to subareas and queuing jobs; however, it is to be appreciated that variations of these methods are possible.

The following segment of code includes functionality that generates the coordinates to queue.

# Priority is Linear, Based on Distance from the Center

module SnoOwl

class HoneyComber

# the ratio of a circle to the upper face of an inscribed hexagon
CIRCLE_TO_HEX_RADIO = 0.8696
# for a given hexagon, how far to move to the left or right to
find
# the center of an adjacent hexagon
HEX_WIDTH_RADIO = 1.7357
# radius is the max radius
# all all parameters in METERS, not KM
def coords(latitude, longitude, radius_in_meters,
max_distance_in_meters)

# track the LatLng we already visited
@already_traversed = Set.new
@traversal_queue = Set.new
@circle_radius = radius_in_meters / 1000.0
# STEP 1... if our radius is 1000 meters, determine our hex
height...
@hex_height_in_meters = radius_in_meters *
CIRCLE_TO_HEX_RADIO
@hex_height_in_kms = @hex_height_in_meters /
1000.0
# STEP 2: figure width
@hex_width_in_kms = @hex_height_in_kms *
HEX_WIDTH_RADIO
@origin = Geokit::LatLng.new(latitude, longitude)
@traversal_queue << @origin
@already_traversed << @origin
traverse_nodes(max_distance_in_meters / 1000)
return @already_traversed.to_a

end

def traverse_nodes(max_distance_in_kms)

until @traversal_queue.length == 0

current_point = @traversal_queue.take!
# 0 = north
north_point = current_point.endpoint(0,

@hex_height_in_kms * 2, {:units => :kms})

# 180 = south
south_point = current_point.endpoint(180,

@hex_height_in_kms * 2, {:units => :kms})

# let's figure out the north WEST point
# we have to start from origin... move up 1 HEX
HEIGHT
# now move to the WEST by @hex_width_kms
north_west_point = current_point.endpoint(0,

@hex_height_in_kms, {:units => :kms}).endpoint(270,
@hex_width_in_kms, {:units => :kms})

# move 180 degrees then 270
south_west_point = current_point.endpoint(180,

@hex_height_in_kms, {:units => :kms}).endpoint(270,
@hex_width_in_kms, {:units => :kms})

# move 0 degrees and then 90
north_east_point = current_point.endpoint(0,

@hex_height_in_kms,{:units => :kms}).endpoint(90,
@hex_width_in_kms, {:units => :kms})

# move 180 degrees and then 90
south_east_point = current_point.endpoint(180,

@hex_height_in_kms, {:units => :kms}).endpoint(90,
@hex_width_in_kms, {:units => :kms})

maybe_queue(north_point, max_distance_in_kms)
maybe_queue(south_point, max_distance_in_kms)
maybe_queue(north_west_point,
max_distance_in_kms)
maybe_queue(north_east_point,
max_distance_in_kms)
maybe_queue(south_west_point,
max_distance_in_kms)
maybe_queue(south_east_point,
max_distance_in_kms)
@already_traversed << current_point

end
return @already_traversed

end
def maybe_queue(point, max_distance_in_kms)

point_distance = point.distance_to(@origin,
{:units => :kms})
unless @already_traversed.include?(point) ∥
any_close_points?(point)

∥ point_distance > max_distance_in_kms

@traversal_queue << point

end

end
def any_close_points?(point)

@already_traversed.each do |traversed_point|

distance = point.distance_to(traversed_point,
{:units => :kms})
if distance < (@circle_radius / 2)

return true

end

end
@traversal_queue.each do |traversed_point|

distance = point.distance_to(traversed_point,
{:units => :kms})
if distance < (@circle_radius / 2)

return true

end

end
return false

end

end

The following segment of code includes functionality that queues based on priority/distance. More specifically, the coordinates generated by the above functions are placed in a job queue which contains metadata about the job (e.g., time queued, priority, longitude, latitude, which user requested the pull). This allows for a balancing of the needs of multiple users making requests and ensures that users are provided with up-to-date content.

honey_comber = SnoOwl::HoneyComber.new
coords = honey_comber.coords(latitude, longitude,

radius_in_meters, maximum_range_in_meters)

max_distance = 0
# ok, now for each coord we want to map it to the max range...
coords.each do |coord|

# add a distance field...
coord.singleton_class.class_eval do

attr_accessor :distance, :priority

end
# calculate range and max
coord.distance = calculate_range(latitude, longitude,

coord.latitude, coord.longitude)

max_distance = coord.distance if coord.distance >
max_distance

end
# now scale to get the priorities
coords.each do |coord|

coord.priority = coord.distance.scale_between(0,

max_distance, 100, 1).round

import_job = SnoOwl::GeoJob.new
import_job.latitude = coord.latitude
import_job.longitude = coord.longitude
import_job.priority = coord.priority
import_job.type = ‘update_location’
import_job.radius = 1000
import_job.created_at = Time.now
import_job = @@GEO_QUEUE.add(import_job)
if import_job.was_duplicate?

return true

end

end

The job processing module 150 may be responsible for dequeuing the information pull requests from the queue. In one implementation, this is achieved by first grabbing the higher priority requests, and then grabbing the oldest jobs. The job processing module 150 can also be used in a per-user fashion, allowing N separate users to have concurrent requests, thereby speeding up the process. An example technique for dequeuing is as follows:

def next(type)

# we want to find the job with the largest priority that's been

waiting the longest

next_job = SnoOwl::GeoJob.where(:type =>

type).order_by(:priority => :desc, :created_at => :asc).first

return next_job

end

In STEP 208, the data ingestion server 110 retrieves from the geospatial data server 120 information associated with one or more of the subareas based at least in part on the assigned priorities. As noted above, jobs associated with coordinate-defined subareas can be queued and then dequeued based on priority and time in queue. Job metadata can be provided in an API call to the geospatial data server 120 in order to identify the relevant information that the geospatial data server 120 should provide. One example of an API call is provided below; however, a wide variety of API calls may be used.

def import_posts_at(latitude, longitude, range_in_meters, since =
previous_time_period)

# Retrieve array of businesses within specific range_in_meters of

longitude, latitude

businesses = SnoOwl::Business.nearest([longitude, latitude],

{:index => ‘location’, :max_dist =>

range_in_meters, :unit => ‘m’}).order_by(:distance).to_a

number_of_posts_imported = 0
businesses.each do |business|

@@IMPORTER.posts_for(business, since) do |post_hash|

# API call to Facebook to import a post
Facebook::Importer.ingest_post(post_hash)
number_of_posts_imported += 1

end

end
return number_of_posts_imported

end

The data ingestion server 110 may proceed to dequeue jobs associated with coordinate-defined subareas based on descending priorities. The data ingestion server 110 may select subareas by essentially proceeding in a spiral-like fashion. For example, the subarea with the highest priority may be the first to have its job dequeued. This subarea will serve as the center of the spiral. The subareas that surround this first subarea will be next, with subareas surrounding this second layer of subareas to follow.

In STEP 210, the data ingestion server 110 provides the retrieved information to the user device(s) 130a . . . 130n. The data ingestion server 110 can process the information into a format usable by user devices 130a . . . 130n. In other implementations, the user devices 130a . . . 130n perform some or all of the processing on the retrieved information to put it in a usable format. The user device 130a . . . 130n can then display some form of the information to a user in a native application, web application, or otherwise.

It is also contemplated that the geospatial queuing systems and methods of various embodiments described herein may use any type of suitable machine learning procedures. These may include any type of supervised and/or unsupervised machine learning techniques to, for example, provide data regarding certain people, certain businesses, as well as optimal times to provide such data to users or businesses.

Some embodiments of the systems and methods described herein may also consider temporal-related data in assigning priorities. For example, the data ingestion server 110 may assign higher priorities to locations associated with users or businesses that frequently use the systems and methods of the various embodiments described herein.

The terms and expressions employed herein are used as terms and expressions of description and not of limitation, and there is no intention, in the use of such terms and expressions, of excluding any equivalents of the features shown and described or portions thereof. In addition, having described certain implementations in the present disclosure, it will be apparent to those of ordinary skill in the art that other implementations incorporating the concepts disclosed herein can be used without departing from the spirit and scope of the invention. For example, although the techniques described herein are directed to obtaining geospatial data from a social media platform, these techniques are equally applicable to obtaining other types of data from other data sources, where the data is made accessible through an API that may limit queries by rate, area of interest, user token or otherwise.

The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method comprising:
dividing a representation of a geographical area into a plurality of subareas;
receiving a request for information relating to a location of a user device in a first one of the subareas;
assigning a different priority to each of the subareas;
retrieving information associated with one or more of the subareas based at least in part on the assigned priorities; and
providing the retrieved information to the user device.

2. The method of claim 1, wherein the subareas comprise circular subareas.

3. The method of claim 2, wherein the circular subareas are arranged in an overlapping honeycomb pattern.

4. The method of claim 1, wherein the retrieved information comprises at least one of a social media post, information associated with a person, information associated with a business, and information associated with a geographical location.

5. The method of claim 1, wherein the assigning of a priority to a particular subarea is based on a distance of the particular subarea from the location of the user device.

6. The method of claim 1, wherein the assigning comprises:
assigning a first priority to a first one of the subareas; and
assigning a different priority lower than the first priority to each other subarea.

7. The method of claim 1, wherein the information is retrieved via a query-rate-limited application programming interface.

8. The method of claim 1, further comprising:
receiving a request for information relating to a location of a second user device in a second one of the subareas; and
modifying the priority assigned to one or more of the subareas based on a distance of each of the one or more subareas from the location of the second user device.

9. A system comprising:
at least one memory for storing computer-executable instructions; and
at least one processing unit for executing the instructions on the at least one memory, wherein execution of the instructions programs the at least one processing unit to perform operations comprising:
dividing a representation of a geographical area into a plurality of subareas;
receiving a request for information relating to a location of a user device in a first one of the subareas;
assigning a different priority to each of the subareas;
retrieving information associated with one or more of the subareas based at least in part on the assigned priorities; and
providing the retrieved information to the user device.

10. The system of claim 9, wherein the subareas comprise circular subareas.

11. The system of claim 10, wherein the circular subareas are arranged in an overlapping honeycomb pattern.

12. The system of claim 9, wherein the retrieved information comprises at least one of a social media post, information associated with a person, information associated with a business, and information associated with a geographical location.

13. The system of claim 9, wherein the assigning of a priority to a particular subarea is based on a distance of the particular subarea from the location of the user device.

14. The system of claim 9, wherein the assigning comprises:
assigning a first priority to a first one of the subareas; and
assigning a different priority lower than the first priority to each other subarea.

15. The system of claim 9, wherein the information is retrieved via a query-rate-limited application programming interface.

16. The system of claim 9, wherein the operations further comprise:
receiving a request for information relating to a location of a second user device in a second one of the subareas; and
modifying the priority assigned to one or more of the subareas based on a distance of each of the one or more subareas from the location of the second user device.
